(19) United States
(12) Patent Application Publication
(10) Pub. No.: US 2025/0002362 A1
(43) Pub. Date: Jan. 2, 2025

(54) LITHIUM OXIDE MATERIALS AND METHODS OF PRODUCING LITHIUM OXIDE MATERIALS

(71) Applicant: 6K Inc., North Andover, MA (US)

(72) Inventors: Adrian Pullen, Boston, MA (US); Joe Mirus, Duxbury, VT (US); Wyatt Olson, Portland, OR (US); Richard K. Holman, Wellesley, MA (US)

(21) Appl. No.: 18/587,789

(22) Filed: Feb. 26, 2024

Related U.S. Application Data
(60) Provisional application No. 63/487,218, filed on Feb. 27, 2023.

(51) Int. Cl. C01D 15/02; H01M 4/48; H01M 10/0525

(52) U.S. Cl. CPC C01D 15/02; H01M 4/48; H01M 10/0525; C01P 2004/32; C01P 2004/61; C01P 2006/40

(57) ABSTRACT

The embodiments disclosed herein are directed to systems, methods, and compositions of lithium oxides. In various embodiments of the present disclosure, the systems, methods, and compositions are directed to micron-sized lithium oxide particles that are optimally dense and spherical for use in lithium battery applications.

### INCORPORATION BY REFERENCE TO ANY PRIORITY APPLICATIONS

This application claims the priority benefit under 35 U.S.C. § 119 (e) of U.S. Provisional Application No. 63/487,218, filed Feb. 27, 2023, the entire disclosure of which is incorporated herein by reference in its entirety. Any and all applications for which a foreign or domestic priority claim is identified in the Application Data Sheet as filed with the present application are hereby incorporated by reference under 37 CFR 1.57.

### BACKGROUND

### Field

The present disclosure is generally directed to lithium oxide compositions and methods of production thereof.

### Description

Lithium batteries have a high energy density, which is 1.5 to 2 times higher than that of Ni/Cd batteries, when compared at the same volume. Thus, lithium batteries are widely used as a power source for mobile phones, laptops, electric vehicles, and the like. Since lithium batteries as a main component determine performance of the portable products, a need for high performance batteries has emerged. Battery performance is required in various aspects, including high efficiency characteristics, stability at high temperatures, cycle-life, charge/discharge characteristics, etc.

In lithium-ion batteries, lithium cobalt oxide is conventionally used as a cathode material. However, many alternative material systems have been developed and used. Generally, lithium and oxygen are an essential part of the material system.

Lithium oxides may be produced as solid powders for use as electrolytes in solid-state lithium batteries or as cathode material for lithium-ion power batteries. The microstructure, morphology, particle size, and degree and type of possible contamination in the powder play a decisive role in the selection of the powder as a suitable material for use as a battery material in a lithium battery. These properties influence the electrochemical characteristics of the battery. In particular, the energy density is of significant importance. For example, energy density may affect the distance electric vehicles can drive and is influenced by the above-mentioned microstructural parameters.

Thus, new processes for producing lithium oxide materials having optimal particle size and density are needed.

### SUMMARY

For purposes of this summary, certain aspects, advantages, and novel features of the invention are described herein. It is to be understood that not all such advantages necessarily may be achieved in accordance with any particular embodiment of the invention. Thus, for example, those skilled in the art will recognize that the invention may be embodied or conducted in a manner that achieves one advantage or group of advantages as taught herein without necessarily achieving other advantages as may be taught or suggested herein.

Some embodiments herein are directed to a process for producing lithium oxide particles, the process comprising: inputting one or more lithium containing precursor powder materials into a microwave generated plasma; contacting the one or more lithium precursor powder materials with the microwave generated plasma; cooling and solidifying the lithium precursor to form one or more spherical lithium oxide particles; and collecting the one or more spherical lithium oxide particles, wherein the one or more spherical lithium oxide particles have an average particle size less than about 500 μm.

In some embodiments, the one or more spherical lithium oxide particles have an average particle size between about 5 to 500 μm. In some embodiments, the one or more spherical lithium oxide particles have a D50 particle size between about 5 to 50 μm. In some embodiments, the one or more spherical lithium oxide particles have a D50 particle size of about 5 to 15 μm.

In some embodiments, a median sphericity of the one or more spherical lithium oxide particles is greater than 0.5. In some embodiments, a median sphericity of the one or more spherical lithium oxide particles is greater than 0.8. In some embodiments, a median sphericity of the one or more spherical lithium oxide particles is greater than 0.95.

In some embodiments, the bulk average purity of the one or more spherical lithium oxide particles is at least about 20%, at least about 25%, at least about 40%, at least about 60%, at least about 80%, or at least about 95%. In some embodiments, the purity of the one or more spherical lithium oxide particles is at least 99%.

In some embodiments, the apparent density of the one or more spherical lithium oxide particles is at least 1.0 g/cm³. In some embodiments, the apparent density of the one or more spherical lithium oxide particles is at least 2.5 g/cm³. In some embodiments, the one or more spherical lithium oxide particles have an average particle size less than about 250 μm. In some embodiments, the one or more spherical lithium oxide particles have an average particle size less than about 100 μm. In some embodiments, the method further comprises forming the one or more lithium oxide particles into a lithium-ion battery active material.

Some embodiments herein are directed to a lithium oxide powder comprising: one or more lithium oxide (Li₂O) particles, wherein at least 50% of the lithium oxide particles have a sphericity greater than 0.75, and wherein the lithium oxide particles have an average particle size less than about 500 μm.

In some embodiments, the lithium oxide particles have an average particle size less than about 250 μm. In some embodiments, the lithium oxide particles have an average particle size less than about 100 μm. In some embodiments, the apparent density of the one or more lithium oxide particles is at least 1.5 g/cm³. In some embodiments, at least 50%, at least 75%, or at least 90% of the lithium oxide particles have a sphericity greater than 0.9. In some embodiments, at least 50%, at least 75%, or at least 90% of the lithium oxide particles have a sphericity greater than 0.95. In some embodiments, the apparent density of the one or more lithium oxide particles is at least 2.5 g/cm³. In some embodiments, the bulk average purity of the one or more lithium oxide particles is at least about 20%, at least about 25%, at least about 40%, at least about 60%, at least about 80%, or at least about 95%. In some embodiments, the one or more lithium oxide particles have a D50 of about 5 to 15 μm. In some embodiments, at least 90% to about 99.9% of the lithium oxide particles comprise standalone particles.

### BRIEF DESCRIPTION OF THE DRAWINGS

The drawings are provided to illustrate example embodiments and are not intended to limit the scope of the disclosure. A better understanding of the systems and methods described herein will be appreciated upon reference to the following description in conjunction with the accompanying drawings, wherein:

FIG. 1 illustrates an exemplary microwave plasma torch that can be used in the production of materials, according to some embodiments herein.

FIG. 2A illustrates an exemplary microwave plasma torch that includes a side feeding hopper according to some embodiments herein.

FIG. 2B illustrates an exemplary microwave plasma torch that includes a side feeding hopper according to some embodiments herein.

FIG. 3 illustrates an SEM image of LiO₂ particles produced according to some embodiments herein.

FIG. 4 illustrates the mass uptake after CO₂ exposure of the particles after conversion of the particles to Li₂O according to some embodiments herein.

### DETAILED DESCRIPTION

Although certain preferred embodiments and examples are disclosed below, inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be conducted in a manner that achieves or optimizes one advantage or group of advantages as taught herein without necessarily achieving other aspects or advantages as may also be taught or suggested herein.

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the invention is defined solely by the claims. The features illustrated or described in connection with one exemplary embodiment may be combined with the features of other embodiments. Such modifications and variations are intended to be included within the scope of the present technology.

### Lithium Oxide Powder Particles

Some embodiments herein relate to the use of microwave plasma processing to produce micron-sized or smaller lithium oxide particles. The lithium oxide particles may be optimally dense and spherical, enabling the lithium oxide particles to be used in a wide array of applications, such as electrolytes in solid-state lithium batteries or as cathode material for lithium-ion power batteries. The production of lithium oxide particles according to some embodiments herein is energy effective and cost effective, enabling battery storage capabilities that are carbon friendly and environmentally sustainable. Further, lithium oxide particles may be produced in a matter of seconds through a gas phase or in-flight exposure to microwave plasma generated in a microwave plasma apparatus, enabling faster production and scalability.

In accordance with various embodiments herein, the lithium oxide particles may be produced by exposure to microwave plasma, rather than through a solvent gelation method. Further, lithium oxide particles may be produced such that they do not require additional calcination or purification after solidification in the microwave plasma apparatus. Finally, embodiments herein enable the production of lithium oxide particles that are substantially non-porous with optimal density. Plasma apparatuses generate and provide elevated temperature directed flows of plasma for a variety of purposes. The two main types of plasma torches are induction plasma torches and microwave plasma torches. Generally, inductive plasmas suffer from plasma non-uniformity. This non-uniformity leads to limitations on the ability of inductive plasmas to process certain materials. Furthermore, significant differences exist between the microwave plasma apparatuses and other plasma generation torches, such as induction plasma. For example, microwave plasma is hotter on the interior of the plasma plume, while induction is hotter on the outside of the plumes. In particular, the outer region of an induction plasma can reach about 10,000 K while the inside processing region may only reach about 1,000 K. This large temperature difference leads to material processing and feeding problems. Furthermore, induction plasma apparatuses are unable to process feedstocks at low enough temperatures to avoid melting of certain feed materials without extinguishing the plasma. Thus, in some embodiments, microwave plasma is utilized to process lithium oxide particles. In some embodiments, the purity of the lithium oxide particles may be at least about 95%. In some embodiments, the purity of the lithium oxide particles may be at least about 25%, about 26%, about 27%, about 28%, about 29%, about 30%, about 31%, about 32%, about 33%, about 34%, about 35%, about 36%, about 37%, about 38%, about 39%, about 40%, about 41%, about 42%, about 43%, about 44%, about 45%, about 46%, about 47%, about 48%, about 49%, about 50%, about 51%, about 52%, about 53%, about 54%, about 55%, about 56%, about 57%, about 58%, about 59%, about 60%, about 61%, about 62%, about 63%, about 64%, about 65%, about 66%, about 67%, about 68%, about 69%, about 70%, about 71%, about 72%, about 73%, about 74%, about 75%, about 76%, about 77%, about 78%, about 79%, about 80%, about 81%, about 82%, about 83%, about 84%, about 85%, about 86%, about 87%, about 88%, about 89%, about 90%, about 91%, about 92%, about 93%, about 94%, about 95%, about 96%, about 97%, about 98%, about 99%, about 100%, or any values between the aforementioned values, defined as mol % Li₂O.

### Microwave Plasma Apparatus

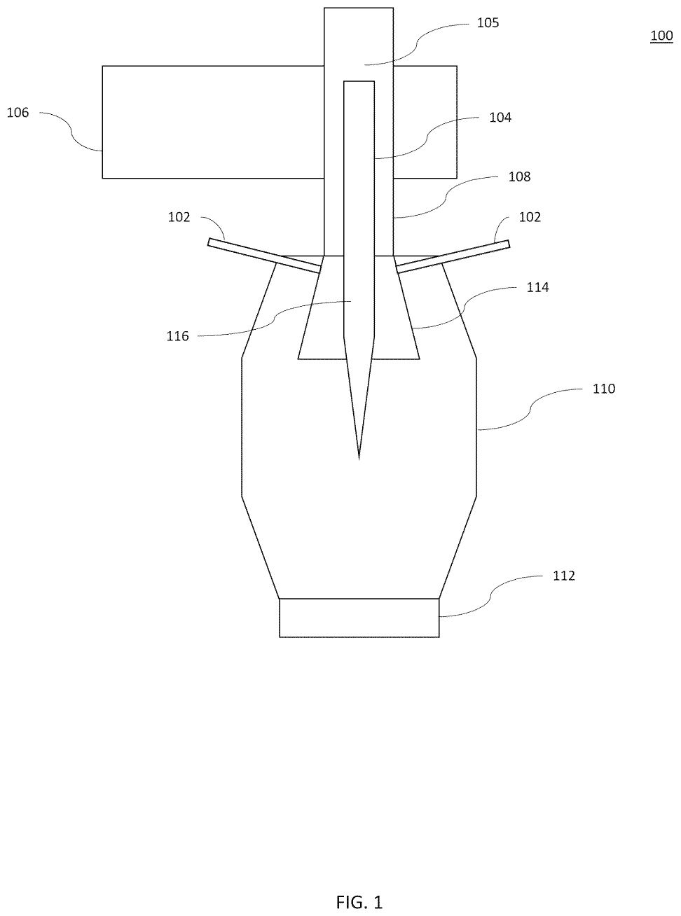

FIG. 1 illustrates an embodiment of a microwave plasma torch 100 that can be used in the production of materials according to some embodiments herein. In some embodiments, a feedstock can be introduced, via one or more feedstock inlets 102, into a microwave plasma 104. In some embodiments, an entrainment gas flow and/or a sheath flow may be injected into the microwave plasma torch 100 to create flow conditions within the plasma torch prior to ignition of the plasma 104 via microwave radiation source 106. In some embodiments, the entrainment flow and sheath flow are both axis-symmetric and laminar, while in other embodiments the gas flows are swirling. In some embodiments, the feedstock may be introduced into the microwave plasma torch 100, where the feedstock may be entrained by a gas flow that directs the materials toward the plasma 104.

As discussed above, the gas flows can comprise a noble gas column of the periodic table, such as helium, neon, argon, etc. Although the gases described above may be used, it is to be understood that a variety of gases can be used depending on the desired material and processing conditions. In some embodiments, within the microwave plasma 104, the feedstock may undergo a physical and/or chemical transformation. Inlets 102 can be used to introduce process gases to entrain and accelerate the feedstock towards plasma 104. In some embodiments, a second gas flow can be created to provide sheathing for the inside wall of a core gas tube 108 and a reaction chamber 110 to protect those structures from melting due to heat radiation from plasma 104.

Various parameters of microwave plasma 104 may be adjusted manually or automatically in order to achieve a desired material. These parameters may include, for example, power, plasma gas flow rates, type of plasma gas, presence of an extension tube, extension tube material, level of insulation of the reactor chamber or the extension tube, level of coating of the extension tube, geometry of the extension tube (e.g. tapered/stepped), feed material size, feed material insertion rate, feed material inlet location, feed material inlet orientation, number of feed material inlets, plasma temperature, residence time and cooling rates. The resulting material may exit the plasma into sealed chamber 112 where the material is quenched then collected.

In some embodiments, the feedstock is injected after the microwave plasma torch applicator for processing in the “plume” or “exhaust” of the microwave plasma torch. Thus, the plasma of the microwave plasma torch is engaged at the exit end of the plasma torch core tube 108, or further downstream. In some embodiments, adjustable downstream feeding allows engaging the feedstock with the plasma plume downstream at a temperature suitable for optimal melting of feedstock through precise targeting of temperature level and residence time. Adjusting the inlet location and plasma characteristics may allow for further customization of material characteristics. Furthermore, in some embodiments, by adjusting power, gas flow rates, pressure, and equipment configuration (e.g., introducing an extension tube), the length of the plasma plume may be adjusted.

In some embodiments, feeding configurations may include one or more individual feeding nozzles surrounding the plasma plume. The feedstock may enter the plasma from any direction and can be fed in 360° around the plasma depending on the placement and orientation of the inlets 102. Furthermore, the feedstock may enter the plasma at a specific position along the length of the plasma 104 by adjusting placement of the inlets 102, where a specific temperature has been measured and a residence time estimated for providing the desirable characteristics of the resulting material.

In some embodiments, the angle of the inlets 102 relative to the plasma 104 may be adjusted, such that the feedstock can be injected at any angle relative to the plasma 104. For example, the inlets 102 may be adjusted, such that the feedstock may be injected into the plasma at an angle of about 0 degrees, about 5 degrees, about 10 degrees, about 15 degrees, about 20 degrees, about 25 degrees, about 30 degrees, about 35 degrees, about 40 degrees, about 45 degrees, about 50 degrees, about 55 degrees, about 60 degrees, about 65 degrees, about 70 degrees, about 75 degrees, about 80 degrees, about 85 degrees, or about 90 degrees relative to the direction of the plasma 104, or between any of the aforementioned values.

In some embodiments, implementation of the downstream injection method may use a downstream swirl or quenching. A downstream swirl refers to an additional swirl component that can be introduced downstream from the plasma torch to keep the powder from the walls of the core tube 108, the reactor chamber 110, and/or an extension tube 114.

In some embodiments, the length of a reaction chamber 110 of a microwave plasma apparatus may be about 1 foot, about 2 feet, about 3 feet, about 4 feet, about 5 feet, about 6 feet, about 7 feet, about 8 feet, about 9 feet, about 10 feet, about 11 feet, about 12 feet, about 13 feet, about 14 feet, about 15 feet, about 16 feet, about 17 feet, about 18 feet, about 19 feet, about 20 feet, about 21 feet, about 22 feet, about 23 feet, about 24 feet, about 25 feet, about 26 feet, about 27 feet, about 28 feet, about 29 feet, or about 30 feet, or any value between the aforementioned values.

In some embodiments, the length of the plasma 104, which may be extended by adjusting various processing conditions and equipment configurations, may be about 1 foot, about 2 feet, about 3 feet, about 4 feet, about 5 feet, about 6 feet, about 7 feet, about 8 feet, about 9 feet, about 10 feet, about 11 feet, about 12 feet, about 13 feet, about 14 feet, about 15 feet, about 16 feet, about 17 feet, about 18 feet, about 19 feet, about 20 feet, about 21 feet, about 22 feet, about 23 feet, about 24 feet, about 25 feet, about 26 feet, about 27 feet, about 28 feet, about 29 feet, or about 30 feet, or any value between the aforementioned values.

In some embodiments, the entrainment flow and sheath flow are both axis-symmetric and laminar, while in other embodiments the gas flows are swirling. The feed materials may be introduced axially into the microwave plasma torch, where they are entrained by a gas flow that directs the materials toward the plasma. Within the microwave generated plasma, the feed materials may be melted or partially melted in order to spheroidize the materials. Inlets can be used to introduce process gases to entrain and accelerate particles towards the plasma. In some embodiments, particles are accelerated by entrainment using a core laminar gas flow created through an annular gap within the plasma torch. A second laminar flow can be created through a second annular gap to provide laminar sheathing for the inside wall of dielectric torch to protect the wall from melting due to heat radiation from plasma. In some embodiments, the laminar flows direct particles toward the plasma along a path as close as possible to a central axis of the plasma, exposing the particles to a substantially uniform temperature within the plasma.

In some embodiments, suitable flow conditions are present to keep particles from reaching the inner wall of the plasma torch where plasma attachment could take place. In some embodiments, particles are guided by the gas flows towards the microwave plasma, where each particle undergoes homogeneous thermal treatment. Various parameters of the microwave generated plasma, as well as particle parameters, may be adjusted in order to achieve desired results. These parameters may include microwave power, feed material size, feed material insertion rate, gas flow rates, plasma temperature, residence time and cooling rates. In some embodiments, the cooling or quenching rate is not less than 10⁺³ degrees C./sec upon exiting the plasma. As discussed above, in some embodiments, the gas flows are laminar; however, in alternative embodiments, swirl flows or turbulent flows may be used to direct the feed materials toward the plasma.

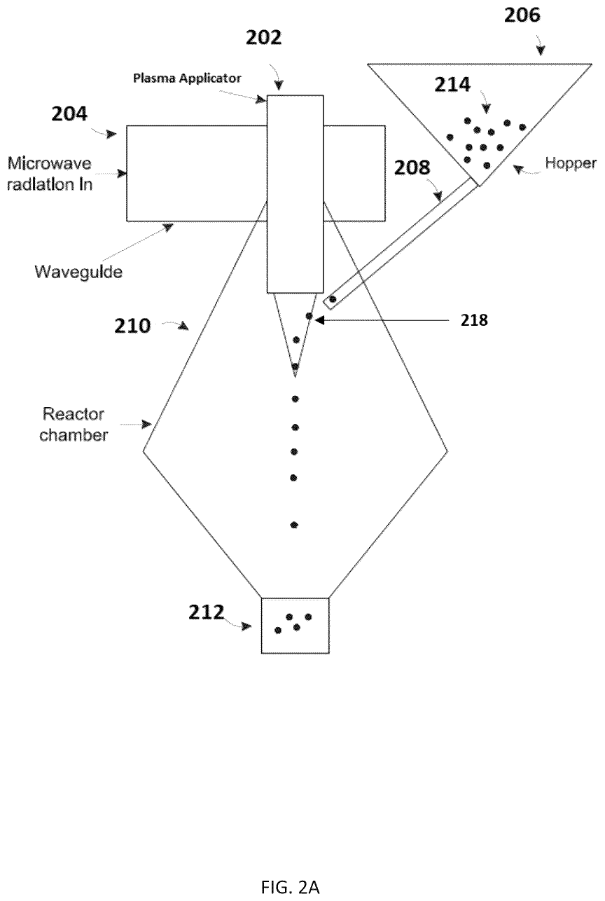

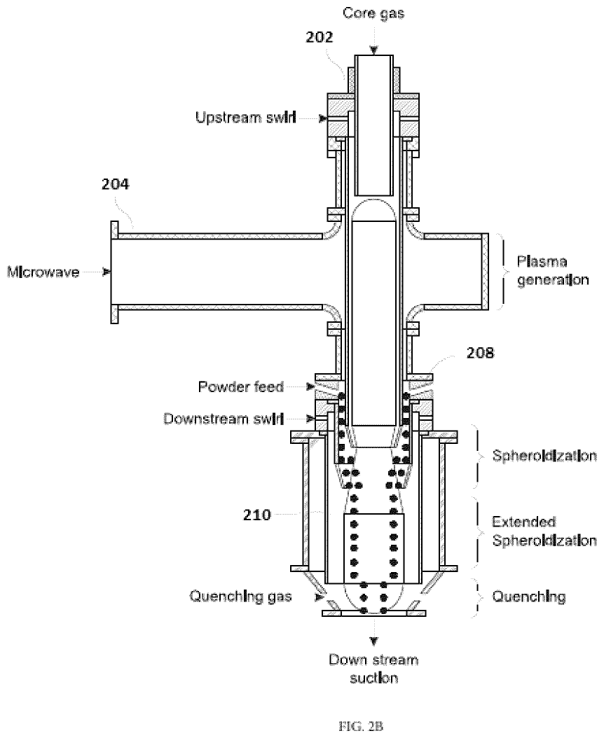

FIGS. 2A-B illustrates an exemplary microwave plasma torch that includes a side feeding hopper, thus allowing for downstream feeding. Thus, in this implementation the feedstock is injected after the microwave plasma torch applicator for processing in the “plume” or “exhaust” of the microwave plasma torch. Thus, the plasma of the microwave plasma torch is engaged at the exit end of the plasma torch to allow downstream feeding of the feedstock. This downstream feeding can advantageously extend the lifetime of the torch as the hot zone is preserved indefinitely from any material deposits on the walls of the hot zone liner. Furthermore, it allows engaging the plasma plume downstream at temperature suitable for optimal processing of powders through precise targeting of temperature level and residence time. For example, there is the ability to dial the length of the plume using microwave powder, gas flows, and pressure in the quenching vessel that contains the plasma plume.

Generally, the downstream spheroidization method can utilize two main hardware configurations to establish a stable plasma plume which are: annular torch, such as described in U.S. Pat. Pub. No. 2018/0297122, or swirl torches described in U.S. Pat. No. 8,748,785 B2 and U.S. Pat. No. 9,932,673 B2, each of which is hereby incorporated by reference in its entirety. A feed system close-coupled with the plasma plume at the exit of the plasma torch is used to feed powder axisymmetrically to preserve process homogeneity.

Other feeding configurations may include one or several individual feeding nozzles surrounding the plasma plume. The feedstock powder can enter the plasma at a point from any direction and can be fed in from any direction, 360° around the plasma, into the point within the plasma. The feedstock powder can enter the plasma at a specific position along the length of the plasma plume where a specific temperature has been measured and a residence time estimated for sufficient melting of the particles. The melted particles exit the plasma into a sealed chamber where they are quenched then collected.

The feed materials 214 can be introduced into a microwave plasma torch 202. Hopper 206 can be used to store the feed material 214 before feeding the feed material 214 into the microwave plasma torch 202, plume, or exhaust. The feed material 214 can be injected at any angle to the longitudinal direction of the plasma torch 202, such as at 5, 10, 15, 20, 25, 30, 35, 40, 45, 50, 55 degrees, or any value between the aforementioned values. In some embodiments, the feedstock can be injected at an angle of greater than 5, 10, 15, 20, 25, 30, 35, 40, 45, 50, or 55 degrees. In some embodiments, the feedstock can be injected at an angle of less than 5, 10, 15, 20, 25, 30, 35, 40, 45, 50, or 55 degrees. In alternative embodiments, the feedstock can be injected along the longitudinal axis of the plasma torch.

The microwave radiation can be brought into the plasma torch through a waveguide 204. Feed material 214 may be fed into a plasma chamber 210 and may be placed into contact with the plasma generated by the plasma torch 202. When in contact with the plasma, plasma plume, or plasma exhaust, the feed material may melt. While still in the plasma chamber 210, the feed material 214 cools and solidifies before being collected into a container 212. Alternatively, the feed material 214 can exit the plasma chamber 210 while still in a melted phase and cool and solidify outside the plasma chamber. In some embodiments, a quenching chamber may be used, which may or may not use positive pressure. While described separately from FIG. 1, the embodiments of FIGS. 2A and 2B are understood to use similar features and conditions to the embodiment of FIG. 1.

### Examples

Various experimental runs were conducted to test the viability of a lithium oxide material produced according to the embodiments herein. In some embodiments, a horizontal twin auger feeder may be used into a downward cross stream of one or more gases, which is directed to a small diameter carrier tube. In some embodiments, the powder injection nozzle is made from ⅜ in tubing with an inner diameter of about 0.305 in with the terminal inch of the tubing flattened to an create inside gap of about 0.10 inches. In some embodiments, the powder injection nozzle is positioned to avoid the hottest part of the plasma plume in order to avoid the problem of exploding particles. In some embodiments, the nozzle may be positioned between about 0 in to about 36 in below the exit of the plasma torch. In some embodiments, the nozzle may be positioned below the exit of the plasma torch at a distance of about 0.0 in, about 0.5 in, about 1.0 in, about 1.5 in, about 2.0 in, about 2.5 in, about 3.0 in, about 3.5 in, about 4.0 in, about 4.5 in, about 5.0 in, about 5.5 in, about 6.0 in, about 6.5 in, about 7.0 in, about 7.5 in, about 8.0 in, about 8.5 in, about 9.0 in, about 9.5 in, about 10.0 in, about 10.5 in, about 11.0 in, about 11.5 in, about 12.0 in, about 12.5 in, about 13.0 in, about 13.5 in, about 14.0 in, about 14.5 in, about 15.0 in, about 15.5 in, about 16.0 in, about 16.5 in, about 17.0 in, about 17.5 in, about 18.0 in, about 18.5 in, about 19.0 in, about 19.5 in, about 20.0 in, about 20.5 in, about 21.0 in, about 21.5 in, about 22.0 in, about 22.5 in, about 23.0 in, about 23.5 in, about 24.0 in, about 24.5 in, about 25.0 in, about 25.5 in, about 26.0 in, about 26.5 in, about 27.0 in, about 27.5 in, about 28.0 in, about 28.5 in, about 29.0 in, about 29.5 in, about 30.0 in, about 30.5 in, about 31.0 in, about 31.5 in, about 32.0 in, about 32.5 in, about 33.0 in, about 33.5 in, about 34.0 in, about 34.5 in, about 35.0 in, about 35.5 in, about 36.0 in, or any value between the aforementioned values.

In some embodiments, one or more quench nozzles may be located between about 1 in to about 120 in below the feed tube. In some embodiments, quenching the particles reduces the particle residence time in the temperature range that promotes carbon dioxide reuptake. In some embodiments, the one or more quench nozzles may be located below the feed tube at a distance of about 1 in, about 2 in, about 3 in, about 4 in, about 5 in, about 6 in, about 7 in, about 8 in, about 9 in, about 10 in, about 11 in, about 12 in, about 13 in, about 14 in, about 15 in, about 16 in, about 17 in, about 18 in, about 19 in, about 20 in, about 21 in, about 22 in, about 23 in, about 24 in, about 25 in, about 26 in, about 27 in, about 28 in, about 29 in, about 30 in, about 31 in, about 32 in, about 33 in, about 34 in, about 35 in, about 36 in, about 37 in, about 38 in, about 39 in, about 40 in, about 41 in, about 42 in, about 43 in, about 44 in, about 45 in, about 46 in, about 47 in, about 48 in, about 49 in, about 50 in, about 51 in, about 52 in, about 53 in, about 54 in, about 55 in, about 56 in, about 57 in, about 58 in, about 59 in, about 60 in, about 61 in, about 62 in, about 63 in, about 64 in, about 65 in, about 66 in, about 67 in, about 68 in, about 69 in, about 70 in, about 71 in, about 72 in, about 73 in, about 74 in, about 75 in, about 76 in, about 77 in, about 78 in, about 79 in, about 80 in, about 81 in, about 82 in, about 83 in, about 84 in, about 85 in, about 86 in, about 87 in, about 88 in, about 89 in, about 90 in, about 91 in, about 92 in, about 93 in, about 94 in, about 95 in, about 96 in, about 97 in, about 98 in, about 99 in, about 100 in, about 101 in, about 102 in, about 103 in, about 104 in, about 105 in, about 106 in, about 107 in, about 108 in, about 109 in, about 110 in, about 111 in, about 112 in, about 113 in, about 114 in, about 115 in, about 116 in, about 117 in, about 118 in, about 119 in, about 120 in, or between any of the aforementioned values.

In some embodiments, there may be one or more collection points post processing. In some embodiments, the first collection vessel (C1) is located directly below the reactor to collect larger particles. In some embodiments, a second collection vessel (CY1) is located below a 1 in feed cyclone to collect the target particle size. In some embodiments, a third collection vessel (BH1) is located below a baghouse to collect undersized particles. Table 1 includes example conversion and yield results for a test according to some embodiments herein.

TABLE 1

| Sample Location | % Li₂O by Mass | % Mass by Location |
|---|---|---|
| C1 | 33.2 | 4.1 |
| CY1 | 90.2 | 60.5 |
| BH1 | 6.4 | 35.4 |

In some embodiments, the lithium carbonate feedstock rate may be about 0.22 kg/hr. In some embodiments, the lithium carbonate feedstock rate may about 0.01 kg/hr to about 1.00 kg/hr. In some embodiments, the lithium carbonate feedstock rate may about 0.01 kg/hr, about 0.02 kg/hr, about 0.03 kg/hr, about 0.04 kg/hr, about 0.05 kg/hr, about 0.06 kg/hr, about 0.07 kg/hr, about 0.08 kg/hr, about 0.09 kg/hr, about 0.10 kg/hr, about 0.11 kg/hr, about 0.12 kg/hr, about 0.13 kg/hr, about 0.14 kg/hr, about 0.15 kg/hr, about 0.16 kg/hr, about 0.17 kg/hr, about 0.18 kg/hr, about 0.19 kg/hr, about 0.20 kg/hr, about 0.21 kg/hr, about 0.22 kg/hr, about 0.23 kg/hr, about 0.24 kg/hr, about 0.25 kg/hr, about 0.26 kg/hr, about 0.27 kg/hr, about 0.28 kg/hr, about 0.29 kg/hr, about 0.30 kg/hr, about 0.31 kg/hr, about 0.32 kg/hr, about 0.33 kg/hr, about 0.34 kg/hr, about 0.35 kg/hr, about 0.36 kg/hr, about 0.37 kg/hr, about 0.38 kg/hr, about 0.39 kg/hr, about 0.40 kg/hr, about 0.41 kg/hr, about 0.42 kg/hr, about 0.43 kg/hr, about 0.44 kg/hr, about 0.45 kg/hr, about 0.46 kg/hr, about 0.47 kg/hr, about 0.48 kg/hr, about 0.49 kg/hr, about 0.50 kg/hr, about 0.51 kg/hr, about 0.52 kg/hr, about 0.53 kg/hr, about 0.54 kg/hr, about 0.55 kg/hr, about 0.56 kg/hr, about 0.57 kg/hr, about 0.58 kg/hr, about 0.59 kg/hr, about 0.60 kg/hr, about 0.61 kg/hr, about 0.62 kg/hr, about 0.63 kg/hr, about 0.64 kg/hr, about 0.65 kg/hr, about 0.66 kg/hr, about 0.67 kg/hr, about 0.68 kg/hr, about 0.69 kg/hr, about 0.70 kg/hr, about 0.71 kg/hr, about 0.72 kg/hr, about 0.73 kg/hr, about 0.74 kg/hr, about 0.75 kg/hr, about 0.76 kg/hr, about 0.77 kg/hr, about 0.78 kg/hr, about 0.79 kg/hr, about 0.80 kg/hr, about 0.81 kg/hr, about 0.82 kg/hr, about 0.83 kg/hr, about 0.84 kg/hr, about 0.85 kg/hr, about 0.86 kg/hr, about 0.87 kg/hr, about 0.88 kg/hr, about 0.89 kg/hr, about 0.90 kg/hr, about 0.91 kg/hr, about 0.92 kg/hr, about 0.93 kg/hr, about 0.94 kg/hr, about 0.95 kg/hr, about 0.96 kg/hr, about 0.97 kg/hr, about 0.98 kg/hr, about 0.99 kg/hr, about 1.00 kg/hr, or any value between the aforementioned values.

In some embodiments, a core plasma gas may be injected at a flow of about 175 slpm. In some embodiments, the plasma gas may comprise nitrogen gas. In some embodiments, a core plasma gas may be injected at a flow of between about 10 slpm to about 400 slpm. In some embodiments, a core plasma gas may be injected at a flow of about 10 slpm, about 15 slpm, about 20 slpm, about 25 slpm, about 30 slpm, about 35 slpm, about 40 slpm, about 45 slpm, about 50 slpm, about 55 slpm, about 60 slpm, about 65 slpm, about 70 slpm, about 75 slpm, about 80 slpm, about 85 slpm, about 90 slpm, about 95 slpm, about 100 slpm, about 105 slpm, about 110 slpm, about 115 slpm, about 120 slpm, about 125 slpm, about 130 slpm, about 135 slpm, about 140 slpm, about 145 slpm, about 150 slpm, about 155 slpm, about 160 slpm, about 165 slpm, about 170 slpm, about 175 slpm, about 180 slpm, about 185 slpm, about 190 slpm, about 195 slpm, about 200 slpm, about 205 slpm, about 210 slpm, about 215 slpm, about 220 slpm, about 225 slpm, about 230 slpm, about 235 slpm, about 240 slpm, about 245 slpm, about 250 slpm, about 255 slpm, about 260 slpm, about 265 slpm, about 270 slpm, about 275 slpm, about 280 slpm, about 285 slpm, about 290 slpm, about 295 slpm, about 300 slpm, about 305 slpm, about 310 slpm, about 315 slpm, about 320 slpm, about 325 slpm, about 330 slpm, about 335 slpm, about 340 slpm, about 345 slpm, about 350 slpm, about 355 slpm, about 360 slpm, about 365 slpm, about 370 slpm, about 375 slpm, about 380 slpm, about 385 slpm, about 390 slpm, about 395 slpm, about 400 slpm, or any value between the aforementioned values.

In some embodiments, a swirl plasma gas may be injected at a flow of about 35 slpm. In some embodiments, the swirl plasma gas may comprise nitrogen gas. In some embodiments, a swirl plasma gas may be injected at a flow of between about 5 slpm to about 100 slpm. In some embodiments, a swirl plasma gas may be injected at a flow of about 5 slpm, about 10 slpm, about 15 slpm, about 20 slpm, about 25 slpm, about 30 slpm, about 35 slpm, about 40 slpm, about 45 slpm, about 50 slpm, about 55 slpm, about 60 slpm, about 65 slpm, about 70 slpm, about 75 slpm, about 80 slpm, about 85 slpm, about 90 slpm, about 95 slpm, about 100 slpm,

In some embodiments, the plasma torch may be activated at about 18 kw power and then adjusted to maintain an exit temperature of about 740° C. In some embodiments, the plasma torch power may be maintained between about 1 kw and about 50 kw. In some embodiments, the plasma torch power may be maintained at about 1 kw, about 2 kw, about 3 kw, about 4 kw, about 5 kw, about 6 kw, about 7 kw, about 8 kw, about 9 kw, about 10 kw, about 11 kw, about 12 kw, about 13 kw, about 14 kw, about 15 kw, about 16 kw, about 17 kw, about 18 kw, about 19 kw, about 20 kw, about 21 kw, about 22 kw, about 23 kw, about 24 kw, about 25 kw, about 26 kw, about 27 kw, about 28 kw, about 29 kw, about 30 kw, about 31 kw, about 32 kw, about 33 kw, about 34 kw, about 35 kw, about 36 kw, about 37 kw, about 38 kw, about 39 kw, about 40 kw, about 41 kw, about 42 kw, about 43 kw, about 44 kw, about 45 kw, about 46 kw, about 47 kw, about 48 kw, about 49 kw, about 50 kw, or any value between the aforementioned values.

In some embodiments, a waveguide gas may be injected at a flow of about 30 slpm. In some embodiments, the waveguide gas may comprise nitrogen gas. In some embodiments, a waveguide gas may be injected at a flow of between about 5 slpm to about 100 slpm. In some embodiments, a waveguide gas may be injected at a flow of about 5 slpm, about 10 slpm, about 15 slpm, about 20 slpm, about 25 slpm, about 30 slpm, about 35 slpm, about 40 slpm, about 45 slpm, about 50 slpm, about 55 slpm, about 60 slpm, about 65 slpm, about 70 slpm, about 75 slpm, about 80 slpm, about 85 slpm, about 90 slpm, about 95 slpm, about 100 slpm,

In some embodiments, a quench gas may be injected at a flow of about 280 slpm. In some embodiments, the quench gas may comprise nitrogen gas. In some embodiments, a quench gas may be injected at a flow of between about 5 slpm to about 400 slpm. In some embodiments, a waveguide gas may be injected at a flow of about 5 slpm, about 10 slpm, about 15 slpm, about 20 slpm, about 25 slpm, about 30 slpm, about 35 slpm, about 40 slpm, about 45 slpm, about 50 slpm, about 55 slpm, about 60 slpm, about 65 slpm, about 70 slpm, about 75 slpm, about 80 slpm, about 85 slpm, about 90 slpm, about 95 slpm, about 100 slpm, about 105 slpm, about 110 slpm, about 115 slpm, about 120 slpm, about 125 slpm, about 130 slpm, about 135 slpm, about 140 slpm, about 145 slpm, about 150 slpm, about 155 slpm, about 160 slpm, about 165 slpm, about 170 slpm, about 175 slpm, about 180 slpm, about 185 slpm, about 190 slpm, about 195 slpm, about 200 slpm, about 205 slpm, about 210 slpm, about 215 slpm, about 220 slpm, about 225 slpm, about 230 slpm, about 235 slpm, about 240 slpm, about 245 slpm, about 250 slpm, about 255 slpm, about 260 slpm, about 265 slpm, about 270 slpm, about 275 slpm, about 280 slpm, about 285 slpm, about 290 slpm, about 295 slpm, about 300 slpm, about 305 slpm, about 310 slpm, about 315 slpm, about 320 slpm, about 325 slpm, about 330 slpm, about 335 slpm, about 340 slpm, about 345 slpm, about 350 slpm, about 355 slpm, about 360 slpm, about 365 slpm, about 370 slpm, about 375 slpm, about 380 slpm, about 385 slpm, about 390 slpm, about 395 slpm, about 400 slpm, or any value between the aforementioned values.

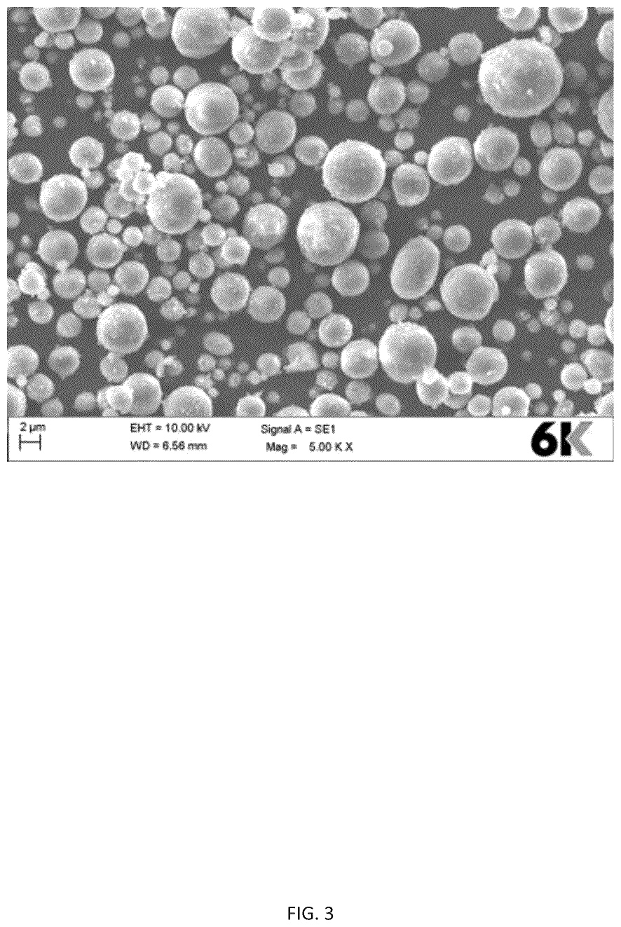

FIG. 3 illustrates an SEM image of LiO₂ particles produced in accordance with embodiments of the present disclosure. The SEM image of the LiO₂ particles has a scale of 2 μm (bottom left), was produced with an electron high tension (EHT) of 10 kilovolts (kV), and has a working distance (WD) of 6.56 mm. As shown in the image, the lithium oxide particles may be substantially or completely standalone, such that each particle is separate from each other particle (i.e., not fused together). The vast majority of the particles in the image are spherical in shape and are not appended to or melded with other spherical lithium oxide particles. In some embodiments, the lithium oxide particles produced and imaged are less than 100 μmin diameter and have an optimal sphericity, as the vast majority of the particles exist as standalone particles and have an optimal spherical curvature.

### Standalone Particles

Various embodiments of the present disclosure may describe the lithium oxide particles as “standalone” particles. As used herein, “standalone” particles may be interpreted as a sampling of particles where at least 60% of the particles are not fused to other particles. “Standalone” lithium oxide particles according to the embodiments herein may include particles wherein at least 65%, at least 70%, at least 75%, at least 80%, at least 85%, at least 90%, at least 95%, at least 97%, or at least 99%, or at least 99.9% of the particles are not fused to other particles. In some embodiments, nanosized satellites may be observed on the surface of particles caused by Li₂O condensation during the microwave plasma process. Thus, “standalone” particles include those in which there are not two fused particles wherein the ratio of radii of each particle is within 10:1 to 1:10. In some embodiments, if a particle has a radius of more than 10× the radius of a satellite, the particle may still be considered a “standalone” particle.

The embodiments herein provide superior results to prior processes in that a microwave plasma process provides a cost and energy efficient process to produce lithium oxide particles. For example, the in-flight solidification of lithium oxide particles in a microwave plasma apparatus enables the production of standalone particles that are optimally dense and spherical. Spherical lithium oxide particles may be further used and incorporated into batteries and other energy storage devices, with or without incorporation of additional elements in or on the lithium oxide particle.

### Microwave Plasma Processing

In a microwave plasma process, the feedstock may be entrained in an inert and/or reducing gas environment and injected into the microwave plasma, the microwave plasma plume, or the microwave plasma exhaust. Upon injection into a hot plasma (or plasma plume or exhaust), the feedstock may undergo a physical and/or chemical transformation (e.g., spheroidization). After processing, the resulting material may be released into a chamber filled with an inert gas and directed into hermetically sealed drums where it is stored. This process can be conducted at atmospheric pressure, in a partial vacuum, or at a slightly higher pressure than atmospheric pressure.

In alternative embodiments, the process can be conducted in a low, medium, or high vacuum environment. The process can run in batches or continuously, with the drums being replaced as they fill up with processed material. By controlling the process parameters, such as cooling gas flow rate, residence time, plasma conditions, cooling gas composition, various material characteristics can be controlled.

Residence time of the particles within a hot zone of the plasma can also be adjusted to provide control over the resulting material characteristics. That is, the length of time the particles are exposed to the plasma determines the extent of melting of the feedstock particles (i.e., surface of the particle melted as compared to the inner most portion or core of the particle). Residence time can be adjusted by adjusting such operating variables of particle injection rate and flow rate (and conditions, such as laminar flow or turbulent flow) within the hot zone. Equipment changes can also be used to adjust residence time. For example, residence time can be adjusted by changing the cross-sectional area of the plasma, by, for example, extending the plasma. In some embodiments, extending the plasma may comprise incorporating an extension tube into the microwave plasma apparatus.

In some embodiments, the extension tube may comprise a stepped shape, such that the tube comprises one or more cylindrical volumes extending downward in the reaction chamber, wherein each successive cylindrical volume comprises a larger diameter than each previous cylindrical volume as the tube extends downward in the reaction chamber. In some embodiments, the extension tube may have a conical shape, tapering radially outwards as it extends downward into the reaction chamber. In some embodiments, the extension tube may comprise a single cylindrical volume4. In some embodiments, the feed material inlets may insert feedstock within the extension tube.

In some embodiments, the extension tube may comprise a length of about 1 foot. In some embodiments, the extension tube may comprise a length of about 1 inch, about 2 inches, about 3 inches, about 4 inches, about 5 inches, about 6 inches, about 7 inches, about 8 inches, about 9 inches, about 10 inches, about 11 inches, about 1 foot, about 2 feet, about 3 feet, about 4 feet, about 5 feet, about 6 feet, about 7 feet, about 8 feet, about 9 feet, about 10 feet, about 11 feet, about 12 feet, about 13 feet, about 14 feet, about 15 feet, about 16 feet, about 17 feet, about 18 feet, about 19 feet, about 20 feet, about 21 feet, about 22 feet, about 23 feet, about 24 feet, about 25 feet, about 26 feet, about 27 feet, about 28 feet, about 29 feet, or about 30 feet, or any value between the aforementioned values.

In some embodiments, the feedstock particles are exposed to a temperature profile at between 4,000 and 8,000 K within the microwave plasma. In some embodiments, the particles are exposed to a temperature profile at between 3,000 and 8,000 K within the microwave plasma. In some embodiments, one or more temperature sensors may be located within the microwave plasma torch to determine a temperature profile of the plasma.

In some embodiments, to avoid agglomeration or coalescence, when the feedstock particles melt in the reactor, the feedstock particles need to be well dispersed in the process gases. In some embodiments, dispersion of the feedstock particles may be achieved by using a small diameter carrier tube, which may maximize turbulence of the process gases, while minimizing carrier gas volume so as not to quench the plasma plume. In some embodiments, feeding the feedstock particles using a carrier gas through a small diameter carrier tube prior to contacting the plasma disperses the feedstock particles, such that a desired particle size distribution may be achieved in the resulting powder.

In some embodiments, a carrier gas flow of about 60 standard liters per minute (slpm) may be used to transport the feedstock particles through the small diameter carrier tube and into the plasma. In some embodiments, a carrier gas flow of about 5 slpm to about 100 slpm may be used. In some embodiments, a carrier gas flow may be used having a flow rate of about 5 slpm, about 10 slpm, about 15 slpm, about 20 slpm, about 25 slpm, about 30 slpm, about 35 slpm, about 40 slpm, about 45 slpm, about 50 slpm, about 55 slpm, about 60 slpm, about 65 slpm, about 70 slpm, about 75 slpm, about 80 slpm, about 85 slpm, about 90 slpm, about 95 slpm, about 100 slpm, or any value between the aforementioned values.

In some embodiments, the carrier gas and/or feedstock particles may be flowed through a carrier tube having an inner diameter of about 0.305 in. In some embodiments, the carrier gas and/or feedstock particles may flow through a carrier tube having an inner diameter of about 0.050 in to about 0.500 in. In some embodiments, the carrier gas and/or feedstock particles may flow through a carrier tube having an inner diameter of about 0.050 in, about 0.055 in, about 0.060 in, about 0.065 in, about 0.070 in, about 0.075 in, about 0.080 in, about 0.085 in, about 0.090 in, about 0.095 in, about 0.100 in, about 0.105 in, about 0.110 in, about 0.115 in, about 0.120 in, about 0.125 in, about 0.130 in, about 0.135 in, about 0.140 in, about 0.145 in, about 0.150 in, about 0.155 in, about 0.160 in, about 0.165 in, about 0.170 in, about 0.175 in, about 0.180 in, about 0.185 in, about 0.190 in, about 0.195 in, about 0.200 in, about 0.205 in, about 0.210 in, about 0.215 in, about 0.220 in, about 0.225 in, about 0.230 in, about 0.235 in, about 0.240 in, about 0.245 in, about 0.250 in, about 0.255 in, about 0.260 in, about 0.265 in, about 0.270 in, about 0.275 in, about 0.280 in, about 0.285 in, about 0.290 in, about 0.295 in, about 0.300 in, about 0.305 in, about 0.310 in, about 0.315 in, about 0.320 in, about 0.325 in, about 0.330 in, about 0.335 in, about 0.340 in, about 0.345 in, about 0.350 in, about 0.355 in, about 0.360 in, about 0.365 in, about 0.370 in, about 0.375 in, about 0.380 in, about 0.385 in, about 0.390 in, about 0.395 in, about 0.400 in, about 0.405 in, about 0.410 in, about 0.415 in, about 0.420 in, about 0.425 in, about 0.430 in, about 0.435 in, about 0.440 in, about 0.445 in, about 0.450 in, about 0.455 in, about 0.460 in, about 0.465 in, about 0.470 in, about 0.475 in, about 0.480 in, about 0.485 in, about 0.490 in, about 0.495 in, about 0.500 in, or any value between the aforementioned values.

In some embodiments, particles directed into the hottest part of the plasma plume may generate a high proportion of nano-particles in the collection chamber. In some embodiments, without being limited by theory, it is suspected that the particles are heated too quickly, and carbon dioxide generated from the thermal decomposition does not escape fast enough, which may result in exploding particles. In some embodiments, heating the particles more gently and evenly may prevent this explosion of particles. In some embodiments, more gradual and even heating of the particles may be accomplished by moving the feed nozzle, vertically and/or horizontally, away from the hottest part of the plasma.

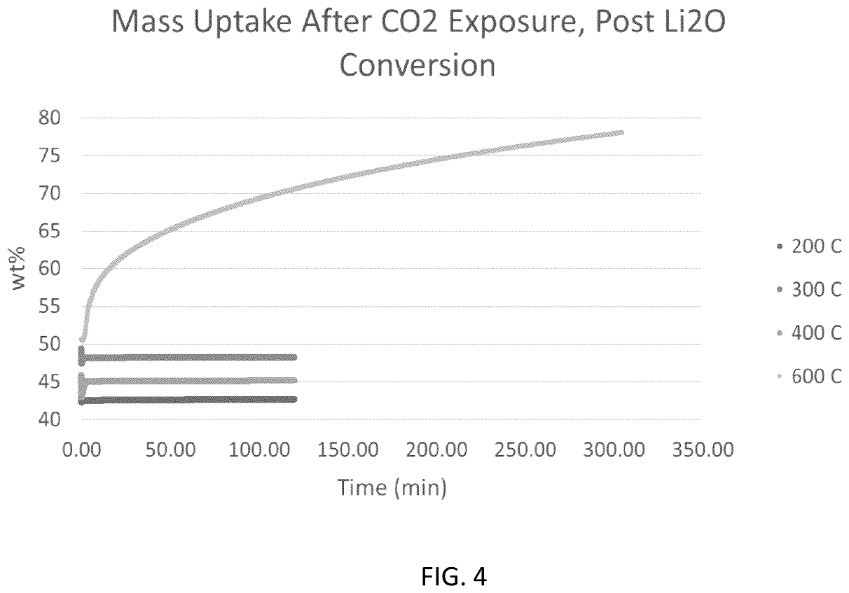

In some embodiments, lithium carbonate is fully converted to lithium oxide. However, carbon dioxide may be undesirably reabsorbed on the surface of the particles to form a lithium carbonate layer on the surface up to about 1 micron deep. Through TGA analysis, it was determined that the reuptake of CO₂ is rapid between temperatures of about 400° C. to about 800° C. (decomposition temperature range). Therefore, in some embodiments, the process is optimized to avoid that temperature range using a quench. In some embodiments, the quench moves the particles through the decomposition temperature range very quickly to avoid the reuptake of CO₂. FIG. 4 illustrates the mass uptake after CO₂ exposure of the particles after conversion of the particles to Li₂O according to some embodiments herein.

### Spheroidization

In some embodiments, the final particles achieved by the plasma processing can be spherical or spheroidal, terms which can be used interchangeably. Advantageously, by using the critical and specific disclosure relevant to each of the different feedstocks disclosed, all of the feedstocks can be transformed into spherical powders. In some embodiments, sphericity may be measured by taking an SEM image of particles produced and measuring 100 adjacent particles. Sphericity of the powder may be taken as the average sphericity of the 100 particles.

Embodiments of the present disclosure are directed to producing particles that are substantially spherical or spheroidal or have undergone significant spheroidization. I n some embodiments, spherical, spheroidal or spheroidized particles refer to particles having a sphericity greater than a certain threshold. Particle sphericity can be calculated by calculating the surface area of a sphere A_{s,ideal} with a volume matching that of the particle, V using the following equation:

$$\begin{matrix}{r}_{ideal} = \sqrt[2]{\frac{3 V}{4 π}} \\ {A}_{s , ideal} = 4 π {r}_{ideal}^{2}\end{matrix}$$

and then comparing that idealized surface area with the measured surface area of the particle, A_{s,actual}:

$$Sphericity = \frac{{A}_{s , ideal}}{{A}_{s , actual}} .$$

In some embodiments, particles can have a sphericity (also referred to herein as sphericity factor) of greater than 0.5, 0.6, 0.7, 0.75, 0.8, 0.9, 0.91, 0.95, or 0.99 (or greater than about 0.5, about 0.6, about 0.7, about 0.75, about 0.8, about 0.8, about 0.91, about 0.95, or about 0.99). In some embodiments, particles can have a sphericity of 0.75 or greater or 0.91 or greater (or about 0.75 or greater or about 0.91 or greater). In some embodiments, particles can have a sphericity of less than 0.5, 0.6, 0.7, 0.75, 0.8, 0.9, 0.91, 0.95, or 0.99 (or less than about 0.5, about 0.6, about 0.7, about 0.75, about 0.8, about 0.8, about 0.91, about 0.95, or about 0.99). In some embodiments, a particle is considered to be spherical, spheroidal or spheroidized if it has a sphericity at or above any of the aforementioned sphericity values, and in some preferred embodiments, a particle is considered to be spherical if its sphericity is at or about 0.75 or greater or at or about 0.91 or greater.

In some embodiments, a median sphericity of all particles within a given powder can be greater than 0.5, 0.6, 0.7, 0.75, 0.8, 0.9, 0.91, 0.95, or 0.99 (or greater than about 0.5, about 0.6, about 0.7, about 0.75, about 0.8, about 0.8, about 0.91, about 0.95, or about 0.99). In some embodiments, a median sphericity of all particles within a given powder can be less than 0.5, 0.6, 0.7, 0.75, 0.8, 0.9, 0.91, 0.95, or 0.99 (or less than about 0.5, about 0.6, about 0.7, about 0.75, about 0.8, about 0.8, about 0.91, about 0.95, or about 0.99). In some embodiments, a powder is considered to be spheroidized if all or a threshold percentage (as described by any of the fractions below) of the particles measured for the given powder have a median sphericity greater than or equal to any of the aforementioned sphericity values, and in some preferred embodiments, a powder is considered to be spheroidized if all or a threshold percentage of the particles have a median sphericity at or about 0.75 or greater or at or about 0.91 or greater.

In some embodiments, the fraction of particles within a powder that can be above a given sphericity threshold, such as described above, can be greater than 50%, 60%, 70%, 80%, 90%, 95%, or 99% (or greater than about 50%, about 60%, about 70%, about 80%, about 90%, about 95%, or about 99%). In some embodiments, the fraction of particles within a powder that can be above a given sphericity threshold, such as described above, can be less than 50%, 60%, 70%, 80%, 90%, 95%, or 99% (or less than about 50%, about 60%, about 70%, about 80%, about 90%, about 95%, or about 99%).

Particle size distribution and sphericity may be determined by any suitable known technique such as by SEM, optical microscopy, dynamic light scattering, laser diffraction, manual measurement of dimensions using an image analysis software, for example from about 15-30 measures per image over at least three images of the same material section or sample, and any other techniques.

Particle size distribution as referred to herein may be stated in terms of D50 or in terms of average particle size. Average particle size may be calculated as the average of the distribution of particles. D50 is also called the median particle diameter or median particle size. For example, for a powder sample with D50=5 μm, it means 50% of particles are larger than 5 μm and 50% particles are smaller than 5 μm. In some embodiments, the D50 of the particles may be less than 500 μm. In some embodiments, the D50 (average or median) of the particles may be about 5 μm, about 10 μm, about 15 μm, about 20 μm, about 25 μm, about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm, about 95 μm, about 100 μm, about 105 μm, about 110 μm, about 115 μm, about 120 μm, about 125 μm, about 130 μm, about 135 μm, about 140 μm, about 145 μm, about 150 μm, about 155 μm, about 160 μm, about 165 μm, about 170 μm, about 175 μm, about 180 μm, about 185 μm, about 190 μm, about 195 μm, about 200 μm, about 205 μm, about 210 μm, about 215 μm, about 220 μm, about 225 μm, about 230 μm, about 235 μm, about 240 μm, about 245 μm, about 250 μm, about 255 μm, about 260 μm, about 265 μm, about 270 μm, about 275 μm, about 280 μm, about 285 μm, about 290 μm, about 295 μm, about 300 μm, about 305 μm, about 310 μm, about 315 μm, about 320 μm, about 325 μm, about 330 μm, about 335 μm, about 340 μm, about 345 μm, about 350 μm, about 355 μm, about 360 μm, about 365 μm, about 370 μm, about 375 μm, about 380 μm, about 385 μm, about 390 μm, about 395 μm, about 400 μm, about 405 μm, about 410 μm, about 415 μm, about 420 μm, about 425 μm, about 430 μm, about 435 μm, about 440 μm, about 445 μm, about 450 μm, about 455 μm, about 460 μm, about 465 μm, about 470 μm, about 475 μm, about 480 μm, about 485 μm, about 490 μm, about 495 μm, about 500 μm, or any value between the aforementioned values.

### Porosity

In accordance with various embodiments herein, the lithium oxide particles have a reduced porosity. For example, in various embodiments the lithium oxide particles are substantially non-porous. Porosity may be measured in terms of BET (Brunauer, Emmett and Teller) surface area or apparent bulk density. Where porosity is measured in terms of apparent density it may be recorded in terms of g/cm³, g/cc, or kg/m³. Apparent bulk density may be measured as the total mass of a particle divided by the external or apparent volume of the particle. In the powder technology field, the apparent density may also be referred to as the volume density or the particle density. As described herein, apparent density may be measured at atmospheric pressure via tapped or bulk density measurements.

BET surface area may be measured as the physical adsorption of a gas (typically a noble gas) onto the surface of a particle at cryogenic temperatures (typically with supercooled gases). BET surface analysis generates a specific surface area result that may be expressed in units of area per mass of sample (m²/g). However, specific surface area can also be expressed in units of area per volume of sample (m²/cm³).

In some embodiments, processes and compositions are provided whereby lithium oxide comprises an apparent density greater than 0.5 g/cm³, greater than 0.8 g/cm³, greater than 1.0 g/cm³, greater than 1.5 g/cm³, or greater than 2.0 g/cm³. In some embodiments, the lithium oxide is provided with an apparent density of about 2 g/cc to about 5 g/cc, and a porosity of less than 10%, or about 0.1% to about 10%, as measured by a compression process. In some embodiments the porosity of the lithium oxide may be about 0.1%, about 0.35%, about 0.6%, about 0.85%, about 1.1%, about 1.35%, about 1.6%, about 1.85%, about 2.1%, about 2.35%, about 2.6%, about 2.85%, about 3.1%, about 3.35%, about 3.6%, about 3.85%, about 4.1%, about 4.35%, about 4.6%, about 4.85%, about 5.1%, about 5.35%, about 5.6%, about 5.85%, about 6.1%, about 6.35%, about 6.6%, about 6.85%, about 7.1%, about 7.35%, about 7.6%, about 7.85%, about 8.1%, about 8.35%, about 8.6%, about 8.85%, about 9.1%, about 9.35%, about 9.6%, about 9.85%, about 10%, or any value between the aforementioned values.

### Additional Embodiments

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than restrictive sense.

Indeed, although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. In addition, while several variations of the embodiments of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the embodiments of the disclosed invention. Any methods disclosed herein need not be performed in the order recited. Thus, it is intended that the scope of the invention herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in several ways. All possible combinations and subcombinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. No single feature or group of features is necessary or indispensable to each and every embodiment.

It will also be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein but are to be accorded the widest scope consistent with this disclosure, the principles and the novel features disclosed herein.

What is claimed is:

1. A lithium oxide powder comprising:
one or more lithium oxide (Li₂O) particles,
wherein at least 50% of the lithium oxide particles have a sphericity greater than 0.75, and
wherein the lithium oxide particles have an average particle size less than about 500 μm.

2. The composition of claim 1, wherein the lithium oxide particles have an average particle size less than about 250 μm.

3. The composition of claim 1, lithium oxide particles have an average particle size less than about 100 μm.

4. The composition of claim 1, wherein at least 50%, at least 75%, or at least 90% of the lithium oxide particles have a sphericity greater than 0.9.

5. The composition of claim 1, wherein at least 50%, at least 75%, or at least 90% of the lithium oxide particles have a sphericity greater than 0.95.

6. The composition of claim 1, wherein the bulk average purity of the one or more lithium oxide particles is at least about 20%, at least about 25%, at least about 40%, at least about 60%, at least about 80%, or at least about 95%.

7. The composition of claim 1, wherein the one or more lithium oxide particles have a D50 particle size of about 5 to 15 μm.

8. The composition of claim 1, wherein at least 90% to about 99.9% of the lithium oxide particles comprise standalone particles.

9. A process for producing lithium oxide particles, the process comprising:
inputting one or more lithium containing precursor powder materials into a microwave generated plasma;
contacting the one or more lithium precursor powder materials with the microwave generated plasma;
cooling and solidifying the lithium precursor to form one or more spherical lithium oxide particles; and
collecting the one or more spherical lithium oxide particles,
wherein the one or more spherical lithium oxide particles have an average particle size less than about 500 μm.

10. The process of claim 9, wherein the one or more spherical lithium oxide particles have an average particle size between about 5 to 500 μm.

11. The process of claim 9, wherein the one or more spherical lithium oxide particles have a D50 particle size between about 5 to 50 μm.

12. The process of claim 9, wherein the one or more spherical lithium oxide particles have D50 particle size of about 5 to 15 μm.

13. The process of claim 9, wherein a median sphericity of the one or more spherical lithium oxide particles is greater than 0.5.

14. The process of claim 9, wherein a median sphericity of the one or more spherical lithium oxide particles is greater than 0.8.

15. The process of claim 9, wherein a median sphericity of the one or more spherical lithium oxide particles is greater than 0.95.

16. The process of claim 9, wherein the bulk average purity of the one or more spherical lithium oxide particles is at least about 20%, at least about 25%, at least about 40%, at least about 60%, at least about 80%, or at least about 95%.

17. The process of claim 9, wherein the bulk average purity of the one or more spherical lithium oxide particles is at least 99%.

18. The process of claim 9, wherein the one or more spherical lithium oxide particles have an average particle size less than about 250 μm.

19. The process of claim 9, wherein the one or more spherical lithium oxide particles have an average particle size less than about 100 μm.

20. The process of claim 9, further comprising forming the one or more lithium oxide particles into a lithium-ion battery active material.
